(19) United States
(12) Patent Application Publication
(10) Pub. No.: US 2022/0156651 A1
(43) Pub. Date: May 19, 2022

(54) SYSTEM AND METHOD FOR INTELLIGENT TICKETING

(71) Applicant: TixTrack, Inc., Los Angeles, CA (US)

(72) Inventors: Steven A. SUNSHINE, Pasadena, CA (US); Rod GOODMAN, Long Beach, CA (US); Michael ARYA, Pasadena, CA (US); Mike RIPBERGER, Santa Monica, CA (US)

(21) Appl. No.: 17/590,506

(22) Filed: Feb. 1, 2022

Related U.S. Application Data
(63) Continuation of application No. 15/912,394, filed on Mar. 5, 2018.
Application No. 15/912,394 is a division of application No. 14/622,546, filed on Feb. 13, 2015, now abandoned.
(60) Provisional application No. 61/942,641, filed on Feb. 21, 2014.

(51) Int. Cl. G06Q 10/02; G06Q 30/02

(52) U.S. Cl. CPC G06Q 10/02; G06Q 30/0275; G06Q 30/0269

(57) ABSTRACT

A computer-implemented method for improved ticket purchasing/selling process using a ticketing system. The purchasing process of tickets for a user can be facilitated by a web interface having an event selection menu configured to display one or more events having tickets available for purchase. Available inventories for tickets to one or more events can be displayed on an interactive venue map of the web interface. The user can choose desired seats for purchase via the venue map. Additional menus can facilitate the ability for a user to compare show dates, showtimes, and seating availability across different events. The ticketing system can also be configured to collect and process customer data through tracking pixels configured within the one or more pages of the web interface. Subsequently, bidding on digital marketing and advertisement can be conducted using the gathered customer data.

### CROSS-REFERENCES TO RELATED APPLICATIONS

This application is a Continuation of U.S. patent application Ser. No. 15/912,394, filed Mar. 5, 2018, which is a Divisional of U.S. patent application Ser. No. 14/622,546, filed Feb. 13, 2015, which claims the benefit of U.S. Provisional Application No. 61/942,641, filed Feb. 21, 2014, which are incorporated by reference herein for all purposes.

### BACKGROUND OF THE INVENTION

Computer systems and networks have facilitated the task of buying, selling, and transferring goods. For example, global computer networks, such as the Internet, have allowed purchasers to quickly and efficiently seek and purchase goods on-line. One example of a market for goods that has been implemented using computer systems and networks is the secondary event ticket market. The secondary ticket market encompasses all instances in which live event tickets trade after the original point of purchase.

The secondary market exists for several reasons. First, the value of event tickets are especially time sensitive with the ticket losing 100% of its value after the event has occurred. As a result, if a ticket holder cannot attend the event, the only way to realize any value for the ticket is to sell the ticket in the secondary market. Second, venues have a fixed supply of seating, so high-demand events have a supply/demand imbalance resulting in tickets with a greater value than the original issue price (e.g. face value). Some ticket holders are willing to sell their tickets for these high demand events thereby realizing a profit based on their original purchase price. Third, many ticket sellers provide season tickets. Some season ticket holders cannot attend one or more of the season's events and the secondary market provides these season tickets holders with a method to resell the tickets for events that they cannot attend.

There are now a number of internet sites that allow ticket holders to resell tickets to others. Examples include StubHub, Razor Gator, and TicketExchange. These sites list the event for which the ticket is valid, the locations of the seat (typically by section, row, and sometimes seat), the number of adjacent seats that are available, and the prices per ticket for each ticket in the listing. Many sites now offer a general view of the venue to facilitate locating the available ticket within the event venue.

Even with the information provided on any given site, it is still very difficult to compare available tickets to determine the best value. Many different factors determine ticket values, not all of which is obvious to an average customer. From the above, it can be seen that improvements to methods and systems related to the sale and distribution of tickets is highly desirable.

### BRIEF SUMMARY OF THE INVENTION

The present invention generally relates to a system and method for the sale and distribution of tickets. More specifically, the present invention relates to a system and method for an optimized ticketing solution wherein the ticketing system takes current inventory levels into account and then automatically adjusts the advertising for the event, adjusts the inventory that is displayed to the customer (i.e. which inventory is shown to the customer), and adjusts the price of the ticket inventory that is being displayed. Additionally, the present invention relates to a system and method for an optimized ticketing solution where the inventory is displayed in a seat level interactive map.

This invention provides a method to maximize revenue from event tickets through an intelligent ticketing system. This invention provides a method to create demand based on a digital advertising system that is tightly coupled to the purchasing process. This is accomplished by directing advertising at customers based on specific customer attributes combined with knowledge of current inventory status. By example, the system may choose not to target a digital advertisement to a customer because it is know that this customer is more likely to buy and expensive ticket and no inventory is left at the higher price levels.

This invention also provides a method for an improved way of displaying ticket inventory on a mobile or desktop computer. Many ticketing systems do not show a customer where they will be sitting or do not allow the customer a way to easily compare tickets in different parts of the venue to one event or to compare inventory across multiple events. This invention provides a method to show inventory in a visual map of the venue and to easily compare the available inventory across multiple events or within one event. Furthermore, this invention provides a method for dynamically changing the inventory that will be shown based on the amount of inventory that may be available at different price levels or based on the specific demographic segmentation of the customer looking to buy a ticket.

To achieve these and other advantages, as embodied broadly and described herein, a system and method to optimize live event ticketing includes a means for displaying a seat level venue map on a mobile or desktop device where the map can be dynamically altered to display current inventory data that is retrieved from a database. The method includes the ability to embed a scalable vector graphics rendering of a venue inside of html web page and dynamically altering the fill or some other attribute of the scalable vector graphics code so as to reflect the locations where inventory is available for purchase.

In another aspect, the invention includes a system and method for differentiating the available inventory based on price or other metrics such as desirability or value where this differentiation can be based on color, size, or shape of the displayed seat that corresponds to the available inventory. The method includes the ability to retrieve information associated with an available seat from a database where the additional information may include the price of the seat or the value of the seat. The method includes the ability to dynamically alter the fill, size, or some other attribute of the scalable vector graphics code so as to reflect the price or value of the seats locations where inventory is available for purchase.

The method also includes a means for a user to change the event for which the inventory is being displayed without leaving the web page that contains the dynamically alterable venue map display. The method includes the ability to display a list of events that are on sale, the ability for a user to make a selection of one or more events, the ability to retrieve inventory data for the one or more events selected, and the ability to display the available inventory in the venue map.

In another aspect, the invention includes a system and method for dynamically altering the portion of available inventory that will be displayed to a user. The method includes the ability to display all available inventory or some subset of available inventory based on specific variables such as the amount of traffic attempting to buy tickets or the point in time during a sales cycle (e.g. during on-sale or later in the sales cycle). The method includes the ability to adjust the amount or type of inventory displayed to the user based on certain details about the user such as their income level, their family demographics, or other personal data.

In another aspect, the invention includes a system and method for dynamically altering the information requested of a user in order to display the available inventory. The method includes the ability to determine the amount or price of the inventory that a user intends to purchase prior to displaying the available inventory. The method includes the ability to determine whether the user will provide this information based on specific variables such as the amount of traffic attempting to buy tickets or the point in time during a sales cycle (e.g. during on-sale or later in the sales cycle). The method includes the ability to display, in a venue map, only the specific seats that meet the user's exact conditions provided by the user such as the number of tickets and the price of those tickets.

In another aspect, the invention includes a system and method for dynamically providing alternative locations to those chosen by the user. The method includes a means of determining the best seats available in the next higher price range and displaying these seats to the user in the venue map in addition to the seats previously chosen by the user. The method includes a means to display the view from the seat for the seats chosen by the user and for the seats in the next higher price range.

In another aspect, the invention includes a system and method for increasing demand to an event. The invention includes a system and method for coupling a digital advertising engine to the ticket transaction engine and database. The method includes the ability to add tracking pixels in order to re-target existing customers and to find new potential customers. The method includes the dynamic segmentation of different customers purchasing tickets for an event and identifying similar target customers who share these customers demographic or other profiles. The method includes the ability to segment based on price paid or seat location within the venue. The method also includes the ability to associate demographic information, purchasing habits, frequently visited web sites, or other information about customers that is characteristic for those who purchase in specific price levels, locations within the venue, have the highest conversion rate, result in the highest revenue, or represent customers with the highest lifetime value. The method includes the ability to dynamically bid for and place advertisements that are customized for a specific event and a specific type of seat for the event based on specific information about the targeted customer.

Many benefits are recognized through the various embodiments of the present invention described previously and throughout the present specification. Such benefits include a comprehensive and efficient method for determining relative ticket values for specified events or groupings of events, which can be used to provide an easier way for customers to buy tickets and for sellers to sell tickets. Other benefits will be recognized by those of ordinary skill in the art that the mechanisms described can be applied to other communications systems as well.

### BRIEF DESCRIPTION OF THE DRAWINGS

The accompanying drawings, which are included to provide further understanding of the invention and are incorporated in and constitute part of the specification, illustrate embodiments of the invention and together with the description serve to explain the principles of the invention. In the drawings:

FIG. 1 shows a seat selection web page from a mobile web site according to an embodiment of the present invention.

FIG. 2 shows a seat selection web page from a mobile web site after a user has selected seats of interest according to an embodiment of the present invention.

FIG. 3 shows a seat selection web page from a desktop purchasing web site according to an embodiment of the present invention.

FIG. 4 shows a loading seat selection web page of a desktop purchasing web site according to an embodiment of the present invention.

FIG. 5 shows a loaded seat selection web page of a desktop purchasing web site according to an embodiment of the present invention.

FIG. 6 shows a seat selection web page of a desktop purchasing web site having a seat availability comparison submenu according to an embodiment of the present invention.

FIG. 7 shows a seat selection web page of a desktop purchasing web site having an alternative seat availability comparison submenu according to an embodiment of the present invention.

FIG. 8 shows a seat selection web page of a desktop purchasing web site after a user has selected an event according to an embodiment of the present invention.

FIG. 9 shows a seat selection web page of a desktop purchasing web site having seat availability and pricing information according to an embodiment of the present invention.

FIG. 10 shows a seat selection web page of a desktop purchasing web site having seat availability and pricing information with a user designated filter according to an embodiment of the present invention.

FIG. 11 shows a seat selection web page of a desktop purchasing web site having seat availability and pricing information with a user designated filter according to an embodiment of the present invention.

FIG. 12 is a table representing a customer demographic segmentation based on the price of a purchased ticket according to an embodiment of the present invention.

FIG. 13 is a simplified flow diagram illustrating a method for operating a ticketing system according to an embodiment of the present invention.

FIG. 14 is a simplified block diagram illustrating a ticketing system according to an embodiment of the present invention.

### DETAILED DESCRIPTION OF THE INVENTION

The present invention is directed to a method and system for the sale and distribution of goods. More specifically, the present invention is directed to a method and system for determining the optimal ticket for purchase in the original and/or secondary market. The following description is provided to enable any person skilled in the art to make and use the invention and sets forth the best modes contemplated by the inventor for carrying out the invention. References are now made in detail to embodiments of the present invention, examples of which are illustrated in the accompanying drawings.

In addition to tickets that find their way to the secondary market without the primary ticket sellers knowledge, more and more inventory is being directly sold to ticket brokers or sold through other channels such as discounters (e.g. Groupon, Living Social, etc). These discounted markets are used, in part, because primary ticket originators (for instance, concert promoters, family show promoters, etc) cannot properly manage all of the ticket supply that they originate. For instance, a touring group that is putting on 3-8 shows per week per tour will need to manage hundreds of events for each show. Managing the ticket inventory for these shows so as to maximize revenue is currently very labor intensive and it is often easier for promoters to give significant amounts of inventory to third parties for them to sell to avoid having to manage all the inventory themselves. Sometimes this inventory is sold to brokers or third parties at a steep discount and the third party then makes money by reselling the tickets at a higher price.

One reason for this highly manual process is that tools do not exist that can quickly assess demand and relate required price changes to that demand in order to maximize revenue. A second reason is because ticketing systems were designed to complete a transaction, not to maximize revenue so there are little or no automated revenue optimization tools associated with the purchase flow.

An additional challenge is that the purchasing interface for the ticketing system is often very poor, causing frustration to customers and having an inability to accurately differentiate core demand for a product versus the realized demand due to an inadequate purchasing process.

In addition, in many ticketing systems the purchaser is not given enough information about the available inventory, or, in some cases, may be shown too much available inventory. The inventory that is shown is typically based on an algorithm that is not responsive to the need to maximize revenue.

The ticketing system is also not coupled to demand generation. In most cases, advertising and marketing is done based on a general plan and there is no direct link between this plan and the ticketing system or real time sales behavior. In other words, the ticketing system is effectively passive requiring any active changes on the demand or supply end to be the result of some manual effort. The need for this manual intervention makes it expensive and unrealistic to optimize revenue.

Given the challenges in optimizing ticket revenue to an event, either by creating more demand in an intelligent manner or by pricing inventory in an intelligent manner, it is therefore desirable to provide a system and method for intelligent ticketing. Accordingly, embodiments of the present invention are directed to methods and systems for providing an improved ticketing solution. Such methods allow a consumer who is interested in obtaining a ticket to an event to use a simple interface to see the available inventory, can target existing or new customers to buy specific inventory, and can dynamically price inventory to maximize revenue for the event promoter.

In a specific embodiment, the present invention is directed to a method and system for optimizing the prices of inventory in the primary market in real time by integrated date about the rate of sale of tickets at each ticket price, the amount of inventory available at each ticket price, the current prices of tickets being offered in the secondary market, the price that similar events have sold for in the same or comparable markets, and the ability to generate additional potential buyers for the event.

The present invention is also directed to a method and system for displaying tickets for purchase in an optimal manner. Specifically, the present invention displays available inventory in a venue map whether the purchase is being conducted on a desktop or mobile device. Furthermore, this invention is also directed at a method to display available data that does not require the user to change web pages in order to view available inventory to a different event. Furthermore, this invention is directed to a system and method for dynamically optimizing the inventory that is shown to a user based on information about the user or information about the amount or location of the remaining available inventory.

The present invention is also directed to a method and system for dynamically targeting and marketing to perspective customers. Specifically, the present invention determines the demographic profile of a given customer and provides an advertisement to that customer based on information about the economics, family structure, interests, or prior buying habits of that customer. Furthermore, this invention is directed to a system and method for dynamically adjusting the advertisement that will be displayed to a customer of live event tickets based on information about the specific customer combined with information about the remaining available ticket inventory. Further details are provided in the accompanying figures and description below.

The first step to optimizing event revenue is to provide an improved buying experience for the user. Currently, the buying experience on both desktop and mobile systems is challenging to navigate and leads to low conversion rates (the number of those who buy divided by the total that reach the purchasing site). For mobile systems, one of the frustrations is the inability to see where you will be sitting. Other issues include the amount of information that must be input in order to complete a purchase. The present invention provides for a greatly improved mobile buying experience.

In an embodiment, the present invention provides a computer-implemented method for providing a better user ticket purchasing process using a ticketing system having a web interface with one or more pages. This method can include presenting, by the web interface, an event selection menu configured to display one or more events having tickets available for purchase to a user. Another step can involve retrieving, from a ticket database of the ticketing system, an available first inventory for a first event selected by the user. Another step can involve displaying, in a venue map region of the web interface, a first venue map having a plurality of first seats according to the available first inventory, wherein the venue map region and the event selection menu are configured on the same page of the web interface. Also, a step can involve retrieving, by the web interface, a set of desired seats when the user performs a clicking or tapping action on a subset of the plurality of first seats from the first venue map.

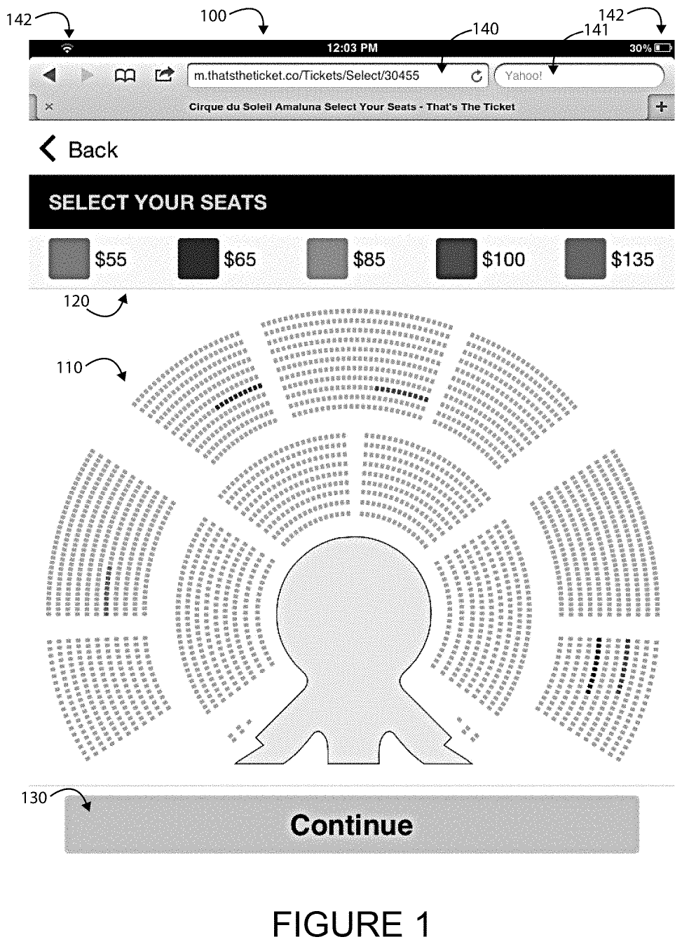

FIG. 1 shows a seat selection web page from a mobile web site according to an embodiment of the present invention. As shown, this page 100 features an interactive seat level venue map 110 created as a scalable vector graphic in which available seats are displayed to the user. In this particular example, a number of seats at each price level are shown by color according to a color-coded pricing legend 120. The seats in each price level are color coded so a user can very easily see the price they would pay depending on location. The user can select their seats by tapping on the specific seats on the interactive venue map that the user is interested in buying. A “continue” button 130 is displayed for the user to press once the user has determined a desired set of seats. This figure also shows a mobile version of a web browser having a url address bar 140, a search bar 141, and device indicators 142.

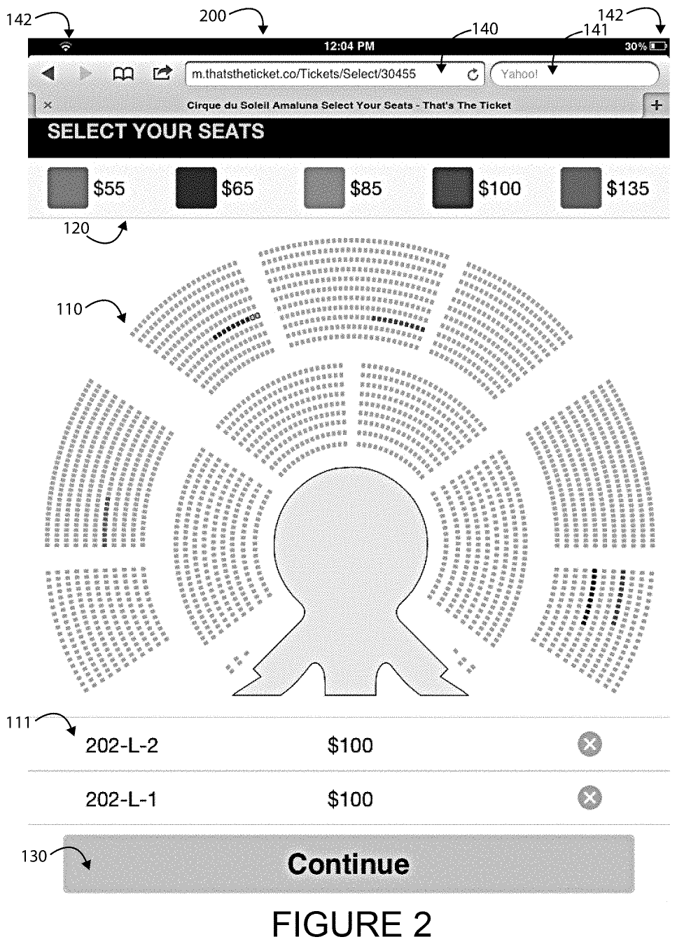

In a specific embodiment, the venue map displayed in the venue map region can be a scalable vector graphic displayed by the web interface. The venue map can be a seat level venue map configured with a color-coded seating scheme based on price levels for each seat from an available inventory retrieved from the ticket database of the ticketing system. In FIGS. 1 and 2, the method for the ticketing system web interface is configured as a mobile computer-implemented ticketing system for portable computing devices such as smartphones, tablets, and the like.

FIG. 2 shows a seat selection web page from a mobile web site after a user has selected seats of interest according to an embodiment of the present invention. In this example page 200, the specific seat locations 111 are shown below the map 110. In another variant, the number of seats selected is shown but not the specific seat locations of each seat. The user may also see the exact seat location prior to the check-out process. This greatly improves user satisfaction and leads to a higher conversion rate. Similar to FIG. 1, once the user has selected all of the seats they are interested in purchasing, they can tap on the continue tab to move to the actual purchasing process. Other elements of page 200 are similar to page 100 of FIG. 1.

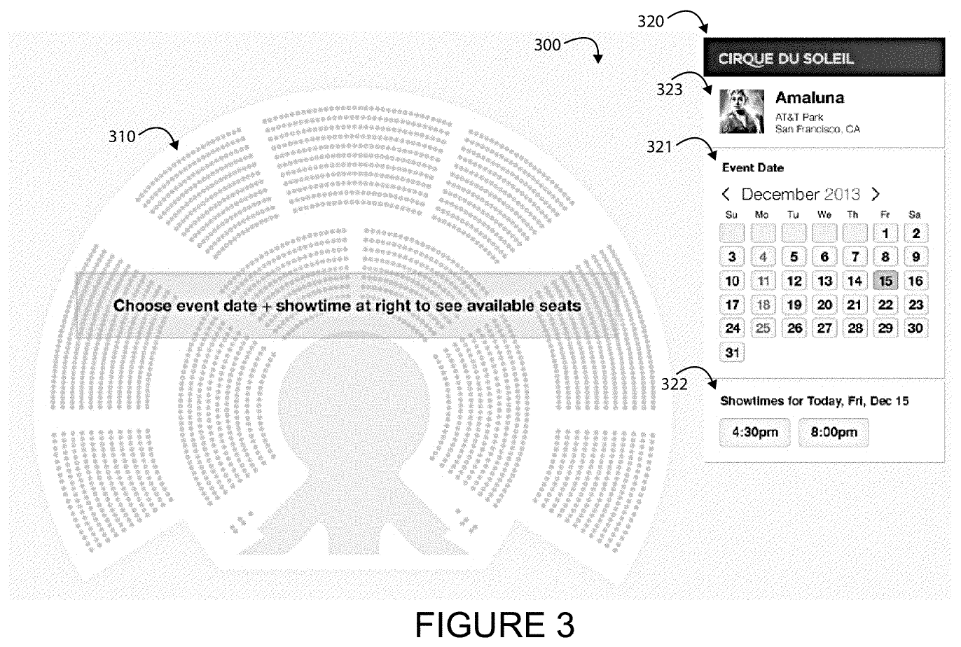

The purchasing process on a desktop can be equally frustrating. While there are ticketing solutions that provide a map of available inventory, these systems require a user to mouse over each seat to see the actual price. In addition, these sites make it difficult to compare available inventory across events. The present invention provides for a page that combines the event selection and seat selection is a single page. A user can choose the event and a venue map, located on the same web page, shows the available inventory for that event. An example is shown in FIG. 3.

FIG. 3 shows a seat selection web page from a desktop purchasing web site according to an embodiment of the present invention. As shown, the web page 300 includes the seat map 310 and the event selection menu 320 functionality located on the same page. In this example, the user taps on a specific date on a calendar 321 and the events that are available on that date appear below the calendar in showtimes submenu 322. In this particular example, the user had previously selected an event type, shown in event submenu 323, so the event list just provides the dates of that event on the date chosen. As an example, the event chosen is “Amaluna” at AT&T Park in San Francisco, Calif. In another version of the page, the list would include different events at different times. Once the user selects the time or event of interest, the map will be populated with the available inventory for that event.

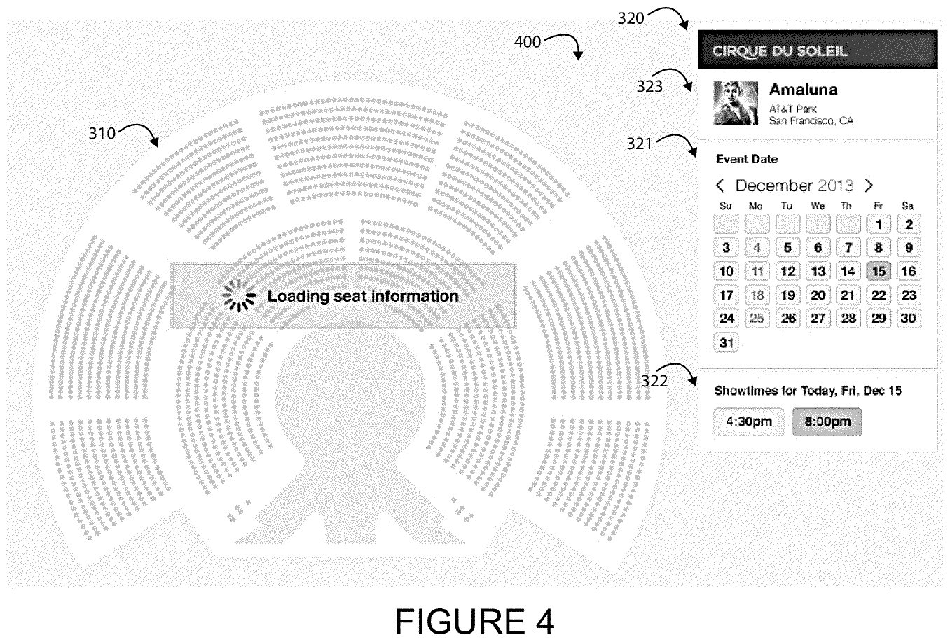

FIG. 4 shows a loading seat selection web page of a desktop purchasing web site according to an embodiment of the present invention. This figure provides an example of a display that a user may experience while available seat data is loaded into the map. As shown in page 400, a loading overlay 330 is provided overlying the seat map 310. Once a user selects a specific event, the user may be shown a message that the inventory data is loading. The presence of this display would depend on the amount of inventory being displayed and the quality of the connection to the ticket database.

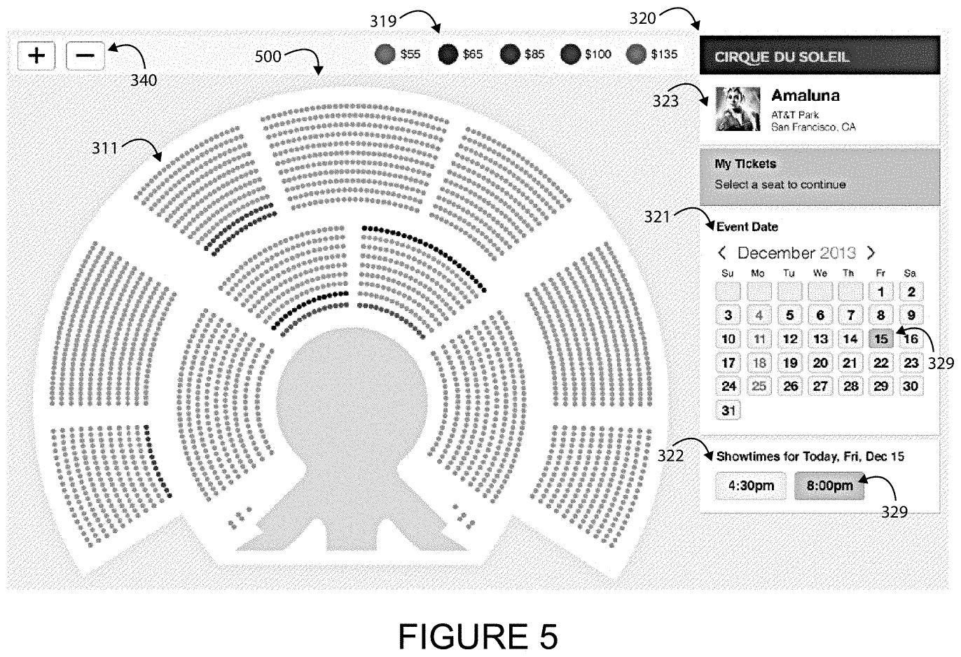

FIG. 5 shows a loaded seat selection web page of a desktop purchasing web site according to an embodiment of the present invention. This figure shows the display once the data has been retrieved from the ticket database. As shown in page 500, multiple seats in the seat map 311 are colored at each price level so that the user can choose their own preferred seats. With the seats being colored based on price, the user can more easily determine which seats to buy from the display of available seats. A seat pricing color key 319 is provided to the upper right of seat map 311. The event information 320 at the right of the map has highlighted regions 329 to indicate the date and time of the event for which the data is being displayed.

In a specific embodiment, the present invention can include a method for a web interface having an event comparison submenu within an event selection menu. This submenu can be configured to allow the user to choose a second event while viewing the available first inventory and the first venue map. Following a selection of a second event by the user, the method can include retrieving, from the ticket database, an available second inventory for the second event selected by the user, and displaying, in the venue map region, a second venue map having a plurality of second seats according to the available second inventory.

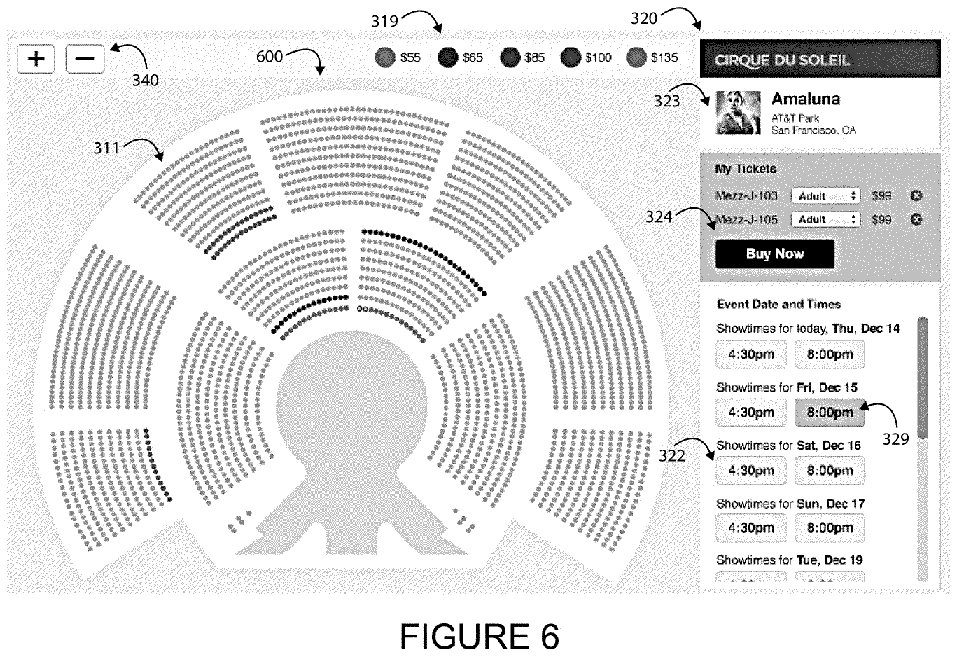

By clicking on a different event, a user can quickly compare inventory between events without having to switch web pages. The page also includes a zoom function 340 that allows the user to enlarge the venue map 310 display without increasing the size of other display elements. Zooming provides an optional method to better choose the seats of interest. When a user does make a seat selection, the seats chosen are highlighted and the seat locations are presented to the user, as shown in FIG. 6.

FIG. 6 shows a seat selection web page of a desktop purchasing web site having a seat availability comparison submenu according to an embodiment of the present invention. This figure shows the web page if a user wants to compare seat availability for a different event after selecting seats for a specific event. As shown in page 600, the user is provided a list of alternative dates and times in the showtimes region 322 and the user can click on a different event and the inventory for that event is displayed in venue map region 311. In this way, a user can simply and quickly compare the available inventory across a number of different events. A seat purchasing menu 324 is also provided within the event selection menu 320. Similar to FIG. 5, a seat pricing color key 319 is provided to the upper right of the venue map region 311.

Typical ticketing web sites have a user select a single desired event at a specific time for which to purchase tickets. In order to view available tickets for another time slot for the same event or even another event, the user would either need to go back in the browser to a previous event search page of the ticketing website to submit a new query, or the user would need to open another window to the same ticketing website in order to submit the new query. In these cases, the user is burdened with either having to take multiple actions in navigating one instance of the ticketing site or having to manually compare between two separate browser windows or two instances of the same ticketing site. As the number of events or showtimes that the user wants to compare increases, the greater the difficulty the user encounters in comparing ticket prices and availability.

In a specific embodiment, the method for the web interface or web page of the present invention can be configured to facilitate a more effective user experience by allowing the user to visually compare seat availability and pricing for more than one event within the same interface or page. The method step of displaying a second venue map can include replacing the first venue map with the second venue map within the venue map region while in the same page of the web interface. This can be applied to a third, fourth, or nth venue map for an nth event chosen by the user. In another example, two or more of the venue maps relating to events chosen by the user can be displayed together for comparison.

As described for FIG. 6, the web interface allows a user to operate the event selection menu to view seat pricing and availability for different showtimes for the same event, or even different events altogether. This accessibility is accomplished by having the venue map region update with information for the new showtime or new event within the same page of the web interface. The user does not have to leave their current page and can easily switch between multiple events within the same page through the event selection menu. In cases in which screen real estate is not an issue, two venue maps showing the available seats for two different events or showtimes can be shown side by side in the venue map region.

As described previously, the user experience for purchasing event tickets is greatly improved by configuring the web page to allow the user to dynamically switch views between event seat inventories. Especially case where screen space is limited (e.g. mobile phone, tablet, etc.), having a single venue map region that updates with the seat availability for the specific venue map of the chosen event is extremely convenient. With the event selection menu configured to one side of the updateable venue map, the number of clicks or taps that a user needs to perform in order to compare tickets is greatly reduced.

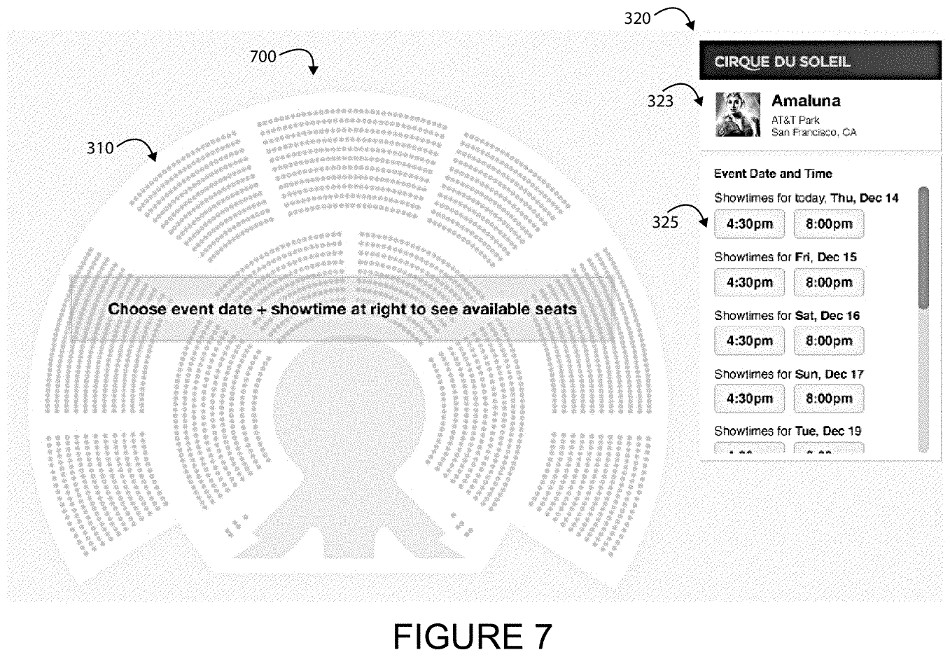

FIG. 7 shows a seat selection web page of a desktop purchasing web site having an alternative seat availability comparison submenu according to an embodiment of the present invention. As shown, page 700 includes an alternative display for the event section 320. In this example, the events are shown in a list form 325 rather than using a calendar format. Events are selected based on the time and date of the show. In this example, all events are the same, but, in some instances, the events could be different, in which case the event name would also be indicated along with the event time.

The display format for the events can either be driven by a calendar or as an event list. If a calendar is used, a user selects a date and all events for that date in the chosen venue will be presented. In the case of the event list, all events are shown in a list and the events show the date and time. Examples for these variations are shown in FIGS. 5 and 7.

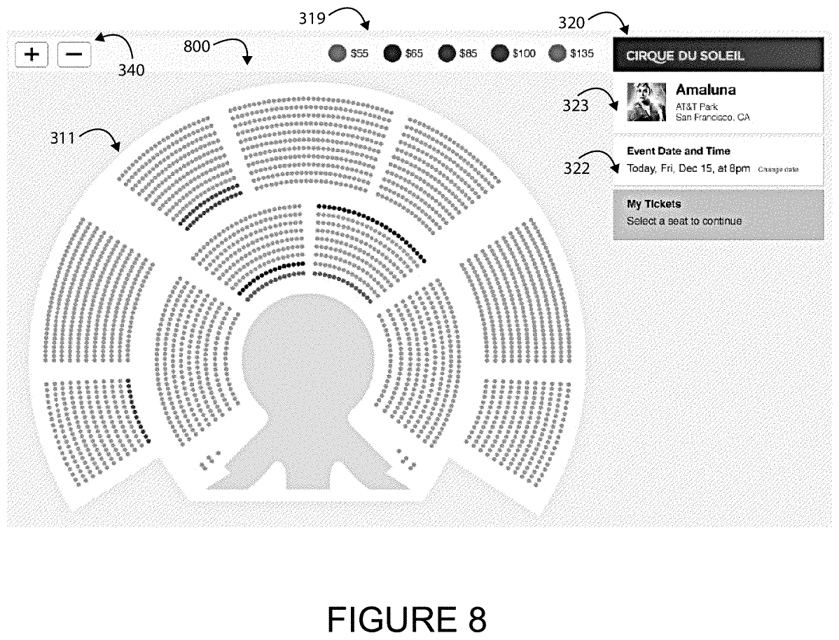

FIG. 8 shows a seat selection web page of a desktop purchasing web site after a user has selected an event according to an embodiment of the present invention. As shown in page 800, the event date and time is selected (shown in event selection region 320) and the inventory has been presented in the seat map 311. Similar to FIG. 5, a seat pricing color key 319 is provided to the upper right of seat map 311.

In addition to the features mentioned above which are important to provide the user with a better buying experience, it is also important that the ticketing system find new buyers and entice users to buy. One key feature to encourage a user on the site to buy is the number of tickets that is shown to the user. If the ticketing system shows too many available seats then the user may feel no sense of urgency. If the ticketing system shows too few seats then the user may not feel that they have a choice and may choose not to buy. In addition, there may be some cases, such as during very high demand periods, when it is important to show specific inventory so as to limit the chance that multiple users are trying to purchase the same seats.

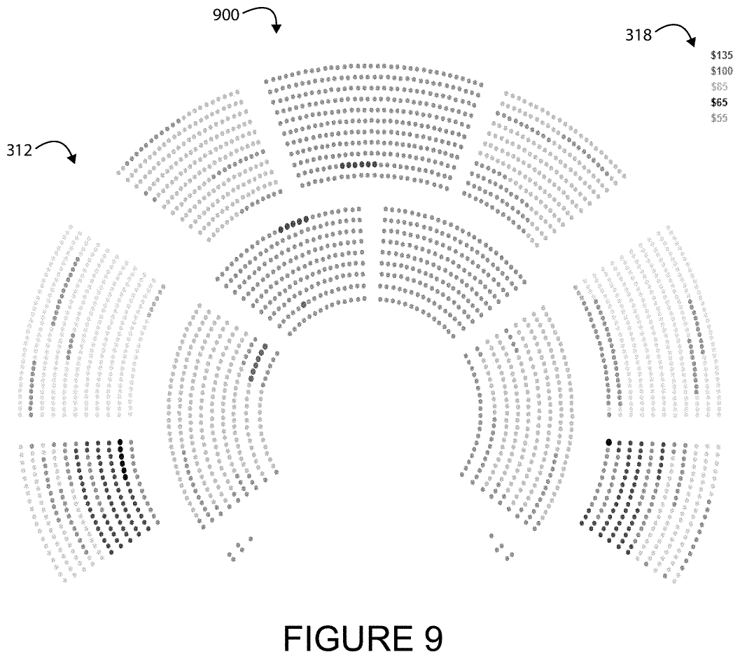

The present invention provides an advanced algorithm, implemented in a computing system, to determine the seats to be presented to the user. The algorithm take in to account the location and price of each available seat. In the case where the user provides no information, the algorithm assesses all available seats and selects the subset of inventory at each price that provides for the best single seat, pair of seats, three seats, etc. Up to an integer ‘n’ number of seats can be used as assessment criteria. For instance, if n is set to 6 seats together, then the algorithm will show the minimum number of seats required to show seats such that the user will have a choice for the best one, two, three, four, five, or six seats together. The variable n is set to maximize the purchasing likelihood. The results of this algorithm are shown in FIG. 9. All available inventory is show as colored seats. In a specific embodiment, the user would only see the darker seats which are the seats selected for display by the algorithm.

FIG. 9 shows a seat selection web page of a desktop purchasing web site having seat availability and pricing information according to an embodiment of the present invention. This page 900 shows an example of the results of an algorithm that determines which available inventory to display to the user on seat map 312. A color-coded pricing key 318 is shown to the upper left. In this view, the lightly colored seats represent the available inventory at each price level.

As described previously, this algorithm includes information about the price and location of each available seat to determine the best available inventory to show to the user. In this embodiment, the inventory is chosen without the need for the user to specify either the price or number of seats they are interested in. In another specific embodiment, the lightly colored seats are not shown to the user so they only see a subset of the available inventory. The algorithm is configurable so that the amount of inventory that is displayed to the user can be dynamically altered based on certain variables, such as information about the purchaser or information about the number of seats available at each price level.

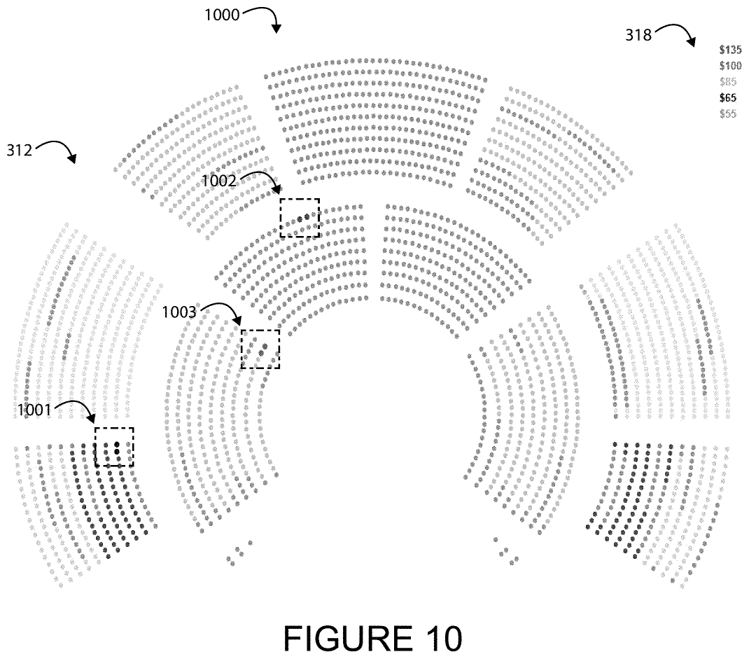

FIG. 10 shows a seat selection web page of a desktop purchasing web site having seat availability and pricing information with a user designated filter according to an embodiment of the present invention. This page 1000 can be an example of the best available algorithm, implemented in a computer system, when a user has previously specified that they want to purchase a certain number of seats at a given price. In seat map 313, the user has specified that they want two tickets at $65 and the best seats are shown in region 1001. Similar to FIG. 9, a color-coded pricing key 318 is shown to the upper left.

In one embodiment, no other inventory would be shown to the user and they would have the ability to select the two seats chosen. In this example, the algorithm has simultaneously determined the seat locations for the best available pair of seats at the next two higher price levels, shown by regions 1002 and 1003. Similar to FIG. 9, a color-coded pricing key 318 is shown to the upper left. In this mode, the user would be presented with the $65 seats that they originally requested along with two other options at higher prices. The user could then select the pair of seats that they choose. In an embodiment, the lighter colored seats are only shown to demonstrate how the best seats are selected and these seats would not be shown to the user.

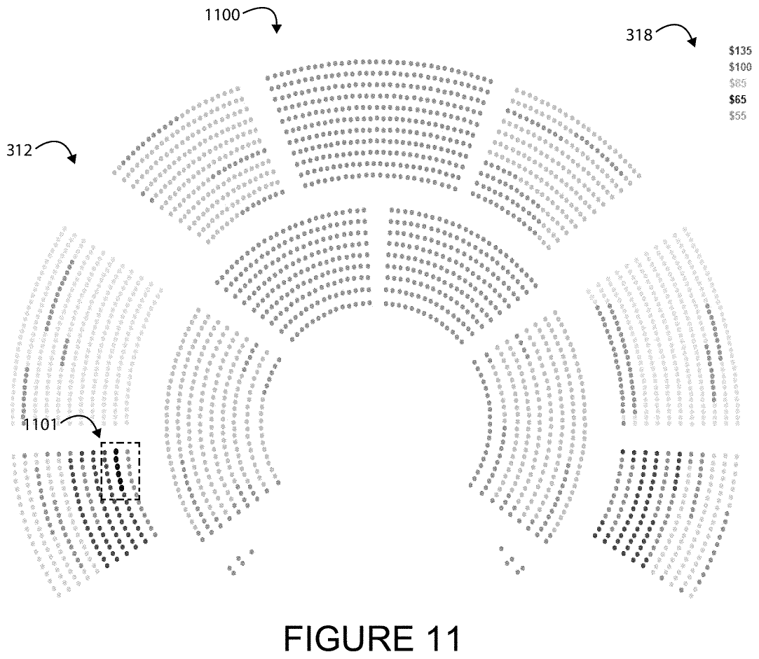

FIG. 11 shows a seat selection web page of a desktop purchasing web site having seat availability and pricing information with a user designated filter according to an embodiment of the present invention. This page 1100 shows the best seats, shown by region 1101, that would be displayed to a user if the user had previously specified that they were interested in purchasing six seats at $65. Similar to FIG. 9, a color-coded pricing key 318 is shown to the upper left.

In certain instances, it may be desirable to ask the user how much they want to spend or how many seats they are looking to buy. In this case, the computer-implemented algorithm only shows available seats that meet these prior inputs. FIG. 11 shows an example where the user had specified the desire to buy six seats at $65. In some instances, it may be desirable to show the user other choices beyond the ones they specified. FIG. 10 shows an example where a user initially requested 2 seats at $65 but the ticketing system presents other locations where 2 seats are available for $100 or $135. By presenting the customer with choices in better locations there is the possibility that the user will upgrade their originally intended purchase. It is also possible to include a view from the three different sets of seats shown to the user so the user can understand the trade-off between location and cost.

In addition to an upgraded seat, the current invention also provides for the ability to include other merchandise with the ticket purchase. Examples can include clothing (e.g. T-shirts, etc), media (e.g. CDs, downloads, etc), or other merchandise (e.g. electronics accessories, food, drinks, etc). These additional upgrade opportunities can provided on the same page as the seat selection. In certain cases, these additional items may be included for free if a customer upgrades their seat location. In other cases, the user may pay directly for these items. If these items are presented on the seat selection page, the items are added to the cart and the appropriate price is indicated at check out and added to their purchase total. In some instances, these additional items may be presented on a cart page after the seat selection process has been completed.

In an embodiment, the present invention can include a computer-implemented ticketing web interface. The web interface can be a web site that is designed so that the seat selection page or the cart page can include additional information in a seamless fashion regardless of the product or promotion. The site can incorporate still photos, music clips, and video. Still photos may include the view from the seat. Those of ordinary skill in the art will recognize other variations, modifications, and alternatives

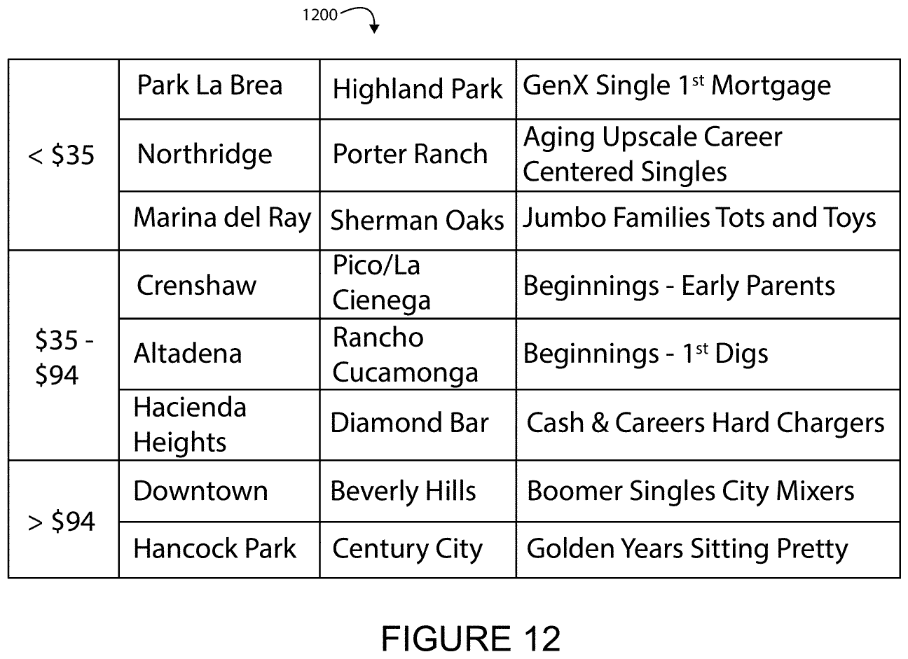

FIG. 12 is a table representing a customer demographic segmentation based on the price of a purchased ticket according to an embodiment of the present invention. In this case, the typical buyer at three different price points (e.g., <$35, $35-$94, and >$94) are shown based on their most likely zip code of residence near the venue where the event will occur along with their demographics at represented by a Prizm code. The Prizm code combines several demographic variables such as income, areas of residence, family situation (e.g. marital status, number of children) to group individuals into a finite number of categories. The segmentation could also use the core variables that are used for the Prizm segmentation rather than the Prizm codes directly.

In an embodiment, the computer-implemented method of the present invention using a ticketing system having a web interface can include performing a customer demographics analysis by an analytics engine. This analysis can include determining a customer demographic segmentation, such as represented by the table of FIG. 12. Using the customer information provided by this demographics segmentation, the web interface can be adapted to present optimal seating selections from a venue map for a user selected event or the user can be targeted digital marketing tailored for a specific demographic.

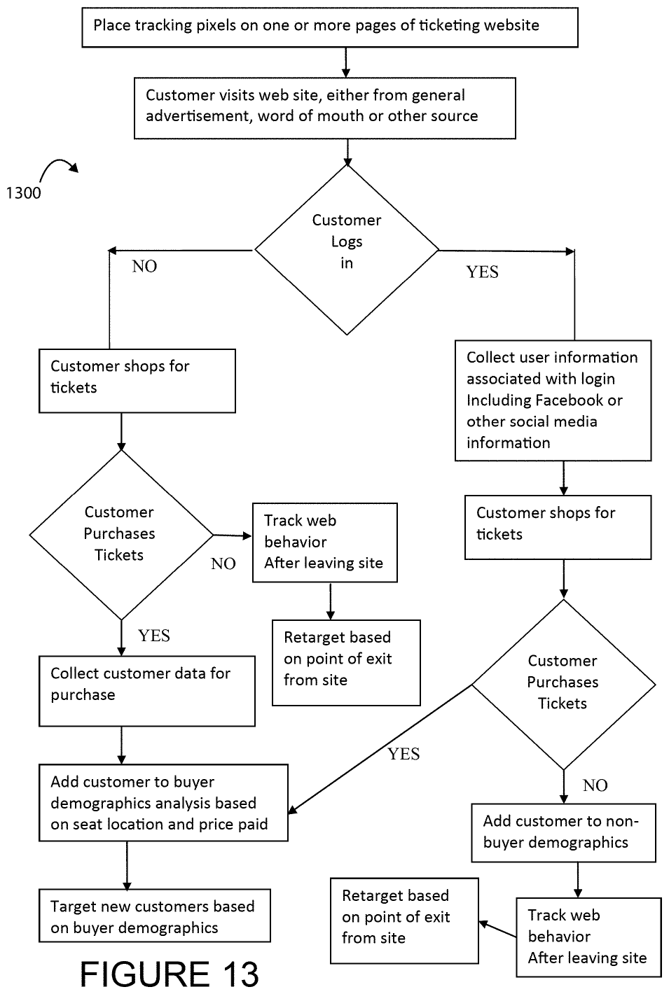

FIG. 13 is a simplified flow diagram illustrating a method for operating a ticketing system according to an embodiment of the present invention. This flow diagram 1300 illustrates the process of a system in which the ticketing engine is tightly coupled to a digital marketing engine. The system determines information about the user, either at login or after the purchasing process, and can store that information into a customer database. Customer information is shared with the digital marketing engine, along with specific information about the location or price that the customer chose and digital advertising is purchased to target similar customers. If a customer does not buy, tracking pixels are used to retarget the customer when they are on other sites.

As shown in FIG. 13, the flow diagram 1300 begins with placing tracking pixels on one or more pages of the ticketing website. This can website can be the web interface for the ticketing system of the present invention. As with any web site, customers may visit this ticketing website by hearing about it from a general advertisement, by word of mouth, etc. Once the customer has accessed the website, the customer may choose to log in or not. Depending on this choice, customer information is obtained by different methods.

In the case that the customer logs in, user information associated with the customer's login can obtained. Examples include a user profile associated with the login, social media networks associated with the login, such as Facebook and Twitter. As the customer shops for tickets on the ticketing website, the customer may decide to purchase tickets to a specific event or forgo purchasing any tickets. If the customer does not make a purchase, this customer can be added to a non-buyer demographics analysis. Web behavior can be tracked after the customer has left the ticketing website, and the customer can be retargeted based on the point of exit from the site. If the customer decides to make a purchase, the customer can be added to buyer demographics analysis based on seat location and price paid. Using this information, new customers can be targeted for future purchases.

In the case that the customer does not log in, the customer does not enter any personal information before browsing for available tickets. Again, the customer may decide to purchase tickets to one or more events, or decide to purchase nothing. Similar to the previous case, if the customer does not buy anything, the tracking pixels can be used to track the web behavior of the customer after leaving the site. These customers can then be retargeted as they surf on to other web sites. If the customer decides to purchase tickets, the customer must enter information related to the purchase. The customer can also be added to the buyer demographics analysis and new customers can be targeted based on this analysis. Although this diagram describes a specific method for a ticketing system, those of ordinary skill in the art will recognize other variations, modifications, and alternatives.

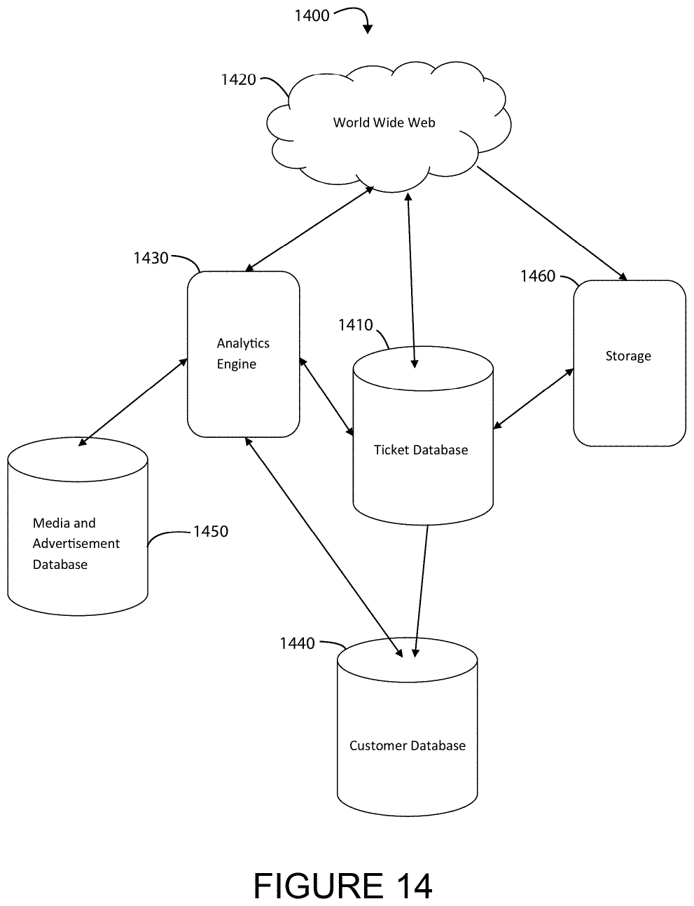

FIG. 14 is a simplified block diagram illustrating a ticketing system according to an embodiment of the present invention. As shown, system 1400 represents the overall structure of the improved ticketing environment. The ticketing database 1410 is connected to the web 1420 where a user can make their purchasing decisions. The ticketing database 1410 is also connected to a customer database 1440 and an analytics engine 1430 that can perform calculations based on the ticket data, the customer data, or the marketing and advertising data from the media and advertisement database 1450. In this way, the best potential customers can be targeted for purchase at the lowest possible advertising cost. Here, a data storage 1460 is connected to the ticket database 1410 and the web 1420.

The present invention also includes a tight coupling of the ticketing process (including ticket database 1410 and storage 1460), digital marketing engine (integrated with analytics engine 1430), and customer database 1450 as shown in FIG. 14. This allows the ticketing system 1400 to customize the purchasing experience based on the specific user. For instance, if the user is determined to be a high net worth individual, the site may preferentially display seats or products directly focused to purchases that are suited to this type of customer. If the user is determined to be someone with a family, the information provided may be specific to someone with a family.

In an embodiment, the present invention provides a computer-implemented method for selling tickets to an event using a ticketing system. This method can include determining, by a ticket database of the ticketing system, an available inventory of tickets remaining for sale for the event. The method can also include determining, by an analytics engine of the ticketing system, a current ticket inventory status, the analytics engine being configured as a digital marketing engine. And the method can include bidding, by a media and advertisement database, on digital marketing based on the current ticket inventory status.

In a specific embodiment, the ticketing system includes a web interface connected to the World Wide Web. This web interface can have one or more web pages configured for a user to determine tickets for purchase. The method can include collecting, by tracking pixels configured within the one or more web pages, customer data including social media data, ticket purchase data, demographic data, and web behavior data. The bidding on digital marketing can involve bidding on a monetary amount based on the customer data determined from the tracking pixels configured within the one or more web pages of the web interface.

In an embodiment, the present invention can provide a computer-implemented method for selling tickets to an event using a ticketing system. This method can include determining, by a customer database of the ticketing system, a set of customers who have already purchased tickets to the event. The method can involve grouping, by an analytics engine of the ticketing system, the members of the set of customers by a price paid for each of the members. This analytics engine can be configured as a digital marketing engine. The method can also include determining, by the customer database and the analytics engine, a demographic profile for each grouping from the set of customers. Furthermore, the method can include bidding, by a media and advertisement database, on digital marketing based on the demographic profiles determined from the set of customers.

In a specific embodiment, the method can include determining, by a ticket database of the ticketing system, a remaining inventory of tickets for the event, the remaining inventory having price level information of remaining tickets. Also, the bidding process on the digital marketing can involve bidding a monetary amount based on the price level information from the remaining inventory and the demographic profiles determined from the set of customers. Of course, there can be other variations, modifications, and alternatives.

This highly coupled system also allows for digital advertising that is based on the ticket inventory status or specific customer information. For instance, if there is an excess of inventory available then the amount of advertising may be increased or the price paid for certain advertisements may be increased. If the demographic profile of customers who are converting is changing, then advertising can be redirected towards other people who share that demographic description. Also, by tracking customers through the purchasing process, customers can be retargeted if they leave the site. By knowing where they left the site and how often they are successfully retargeted, a more informed decision can be made to retarget certain customers based on when they leave the site. The may be at the point that a user abandoned a cart or could involve customers earlier in the buying process. The flow for tracking and retargeting customers is shown in FIG. 13.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A computer-implemented method for providing a better user ticket purchasing process using a ticketing system having a web interface with one or more pages, the method comprising:
presenting, by the web interface, an event selection menu configured to display one or more events having tickets available for purchase to a user;
retrieving, from a ticket database of the ticketing system, an available first inventory for a first event selected by the user;
in response to a number of seats in the an available first inventory being larger than a threshold value:
determining, from among the available first inventory using the customer demographic segmentation, a plurality of first seats that are a subset of the available first inventory;
displaying, in a venue map region of the web interface, a first venue map indicating that only the plurality of first seats are available.

2. A computer-implemented method for providing a better user ticket purchasing process using a ticketing system having a web interface with one or more pages, the method comprising:
presenting, by the web interface, an event selection menu configured to display one or more events having tickets available for purchase to a user;
determining, according to user input to the web interface, a desired number of seats for purchase;
retrieving, from a ticket database of the ticketing system, an available first inventory for a first event selected by the user;
determining, from among the available first inventory using the desired number of seats, a plurality of first seats that are a subset of the available first inventory, wherein each seat in the plurality of first seats being in a respective set of contiguous available seats, each set of contiguous available seats having at least as many contiguous seats as the desired number of seats;
displaying, in a venue map region of the web interface, a first venue map indicating that only the plurality of first seats are available.
